(19) United States
(12) Patent Application Publication
(10) Pub. No.: US 2025/0211776 A1
(43) Pub. Date: Jun. 26, 2025

(54) METHOD AND APPARATUS FOR ENCODING/DECODING IMAGE AND RECORDING MEDIUM STORING BITSTREAM

(71) Applicants: HYUNDAI MOTOR COMPANY, Seoul (KR); KIA CORPORATION, Seoul (KR)

(72) Inventors: Jin Heo, Yongin-si (KR); Seung Wook Park, Yongin-si (KR)

(73) Assignees: HYUNDAI MOTOR COMPANY, Seoul (KR); KIA CORPORATION, Seoul (KR)

(21) Appl. No.: 18/851,609

(22) PCT Filed: Jun. 7, 2023
(86) PCT No.: PCT/KR2023/007749

§ 371 Date: Sep. 26, 2024

(30) Foreign Application Priority Data
Jun. 7, 2022 (KR) 10-2022-0068890
Jun. 7, 2023 (KR) 10-2023-0072622

(51) Int. Cl. H04N 19/52; H04N 19/105; H04N 19/176

(52) U.S. Cl. CPC H04N 19/52; H04N 19/105; H04N 19/176

(57) ABSTRACT

An image decoding method may comprise padding a motion compensation padding area within a first padding distance from a boundary of a current picture according to a motion vector of a boundary block adjacent to the boundary of the current picture, padding a repetitive padding area within a second padding area from a boundary of the motion compensation padding area according to a value of a pixel adjacent to the boundary of the motion compensation padding area, and storing an extended picture composed of the current picture, the motion compensation padding area and the repetitive padding area in a memory.

### TECHNICAL FIELD

The present invention relates to an image encoding/decoding method and apparatus and a recording medium storing a bitstream. More particularly, the present invention relates to an image encoding/decoding method and apparatus using an inter prediction method and a recording medium storing a bitstream.

### BACKGROUND ART

Recently, the demand for high-resolution, high-quality images such as ultra-high definition (UHD) images is increasing in various application fields. As image data becomes higher in resolution and quality, the amount of data increases relatively compared to existing image data. Therefore, when transmitting image data using media such as existing wired and wireless broadband lines or storing image data using existing storage media, the transmission and storage costs increase. In order to solve these problems that occur as image data becomes higher in resolution and quality, high-efficiency image encoding/decoding technology for images with higher resolution and quality is required.

In inter prediction of a picture, a current picture is predicted by referencing a reference picture. At this time, if the current picture references the outside of the boundary of the reference picture, various methods are discussed to improve the prediction accuracy of the current picture. For example, a method of extending a reference picture by padding the outside area of a reference picture boundary is discussed. In addition, various methods for improving prediction accuracy if a current block references a padding area of an extended reference picture in bilateral inter prediction are discussed.

### DISCLOSURE

### Technical Problem

An object of the present invention is to provide an image encoding/decoding method and apparatus with improved encoding/decoding efficiency.

Another object of the present invention is to provide a recording medium for storing a bitstream generated by an image decoding method or apparatus provided by the present invention.

### Technical Solution

An image decoding method according to an embodiment of the present invention may comprise padding a motion compensation padding area within a first padding distance from a boundary of a current picture according to a motion vector of a boundary block adjacent to the boundary of the current picture, padding a repetitive padding area within a second padding area from a boundary of the motion compensation padding area according to a value of a pixel adjacent to the boundary of the motion compensation padding area, and storing an extended picture composed of the current picture, the motion compensation padding area and the repetitive padding area in a memory.

According to an embodiment, the padding the motion compensation padding area may comprise extracting a motion vector from the boundary block, determining a reference block from a motion compensation padding reference picture referenced for motion compensation padding based on the motion vector, determining an adjacent motion compensation padding reference block in a padding direction from the reference block, and padding the motion compensation padding area based on the motion compensation padding reference block.

According to an embodiment, in the determining the motion compensation padding reference block, the motion compensation padding reference block may be determined to include adjacent pixels within the first padding distance in the padding direction from a boundary of the reference block.

According to an embodiment, in the determining the motion compensation padding reference block, when a motion compensation padding referenceable distance between the boundary of the reference block and the boundary of the motion compensation padding reference picture is smaller than the first padding distance, the motion compensation padding reference block may be determined to include adjacent pixels within the motion compensation padding referenceable distance in the padding direction from the boundary of the reference block.

According to an embodiment, in the padding the motion compensation padding area based on the motion compensation padding reference block, when the motion compensation padding referenceable distance between the boundary of the reference block and the boundary of the motion compensation padding reference picture is smaller than the first padding distance, a motion compensation paddable area within the motion compensation padding referenceable distance from the boundary of the current picture of the motion compensation padding area may be padded by the motion compensation padding reference block, and an area that is not the motion compensation paddable area of the motion compensation padding area may be padded based on a pixel value of the motion compensation paddable area.

According to an embodiment, when the motion vector cannot be extracted from the boundary block, the motion compensation padding area may be padded according to a value of a pixel adjacent to the boundary of the current picture.

According to an embodiment, the extracting the motion vector from the boundary block may comprise determining a temporal neighboring block corresponding to a position of the boundary block from a temporal corresponding reference picture of the current picture when the motion vector cannot be extracted from the boundary block and extracting the motion vector from the temporal neighboring block.

According to an embodiment, the first padding distance may be determined based on at least one of a maximum size of a coding unit, a size of the current picture or a size of the boundary block.

According to an embodiment, the first padding distance may be determined to be one of 2, 4, 8, 16, 32, 64, 128 or 256.

According to an embodiment, the second padding distance may be determined based on at least one of a maximum size of a coding unit, a size of the current picture or a size of the boundary block.

According to an embodiment, a size of the extended picture may be determined based on the size of the current picture regardless of a value of the first padding distance.

An image decoding method according to another embodiment of the present invention may comprise determining a first reference picture and a second reference picture referenced by a current picture to predict a current block of the current picture, respectively determining a first reference block and a second reference block from the first reference picture and the second reference picture according to a first motion vector and a second motion vector of the current block, and predicting the current block using at least one of the first reference block or the second reference block depending on whether all pixels of the first reference block are included in the first reference picture and whether all pixels of the second reference block are included in the second reference picture.

According to an embodiment, in the predicting the current block, when some or all of pixels of the first reference block are not included in the first reference picture and all pixels of the second reference block are included in the second reference picture, the current block is predicted based on the second reference block.

According to an embodiment, when some of pixels of the first reference block are not included in the first reference picture and all pixels of the second reference block are included in the second reference picture, a first area of the current block corresponding to positions of pixels included in the first reference picture in the first reference block may be determined by a weighted average of pixels of the first reference block and the second reference block and a second area of the current block corresponding to positions of pixels not included in the first reference picture in the first reference block is predicted only based on the second reference block.

According to an embodiment, in determining whether all pixels of the first reference block are in the first reference picture and whether all pixels of the second reference block are included in the second reference picture, a first motion compensation padding area of the first reference picture may be considered as the first reference picture and a second motion compensation padding area of the second reference picture may be considered as the second reference picture.

An image encoding method according to an embodiment of the present invention may comprise padding a motion compensation padding area within a first padding distance from a boundary of a current picture according to a motion vector of a boundary block adjacent to the boundary of the current picture, padding a repetitive padding area within a second padding area from a boundary of the motion compensation padding area according to a value of a pixel adjacent to the boundary of the motion compensation padding area, and storing an extended picture composed of the current picture, the motion compensation padding area and the repetitive padding area in a memory.

An image encoding method according to another embodiment of the present invention may comprise determining a first reference picture and a second reference picture referenced by a current picture to predict a current block of the current picture, respectively determining a first reference block and a second reference block from the first reference picture and the second reference picture according to a first motion vector and a second motion vector of the current block, and predicting the current block using at least one of the first reference block or the second reference block depending on whether all pixels of the first reference block are included in the first reference picture and whether all pixels of the second reference block are included in the second reference picture.

A non-transitory computer-readable recording medium according to an embodiment of the present invention may store a bitstream generated by the image encoding method.

A transmission method according to an embodiment of the present invention transmits a bitstream generated by the image encoding method.

The features briefly summarized above with respect to the present disclosure are merely exemplary aspects of the detailed description below of the present invention, and do not limit the scope of the present invention.

### Advantageous Effects

The present invention proposes various embodiments of a method of generating an extended picture including a motion compensation padding area to improve prediction accuracy of inter prediction.

In addition, the present invention proposes various embodiments of an efficient bilateral inter prediction method when all or part of a reference block is located in a repetitive padding area or a motion compensation padding area, in order to improve prediction accuracy of inter prediction.

In the present invention, as accuracy of inter prediction is improved, overall encoding efficiency can be improved.

### DESCRIPTION OF DRAWINGS

FIG. 1 is a block diagram showing a configuration of an encoding apparatus according to an embodiment of the present invention.

FIG. 2 is a block diagram showing a configuration of a decoding apparatus according to an embodiment of the present invention.

FIG. 3 is a diagram schematically showing a video coding system to which the present invention is applicable.

FIG. 4 shows an embodiment of an extended picture generated according to a repetitive padding method.

FIG. 5 shows an embodiment of an extended picture generated according to repetitive padding and motion compensation padding.

FIG. 6 shows an embodiment of a method of determining a motion compensation padding area.

FIG. 7 shows an embodiment of an extended picture in which an extended picture area is determined regardless of the size of a motion compensation padding area.

FIG. 8 shows an embodiment of a method of performing motion compensation padding based on temporal neighboring blocks.

FIG. 9 shows an embodiment of a block prediction method by bilateral motion prediction.

FIGS. 10 and 11 illustrate an embodiment of a block prediction method by bilateral motion prediction when a part of a reference block is located outside a reference picture.

FIG. 12 illustrates an embodiment of a block prediction method by bilateral motion prediction when an extended picture has a motion compensation padding area.

FIG. 13 shows an embodiment of an image decoding method according to the present invention.

FIG. 14 shows an embodiment of an image encoding method according to the present invention.

FIG. 15 exemplarily illustrates a content streaming system to which an embodiment according to the present invention is applicable.

### BEST MODE

An image decoding method according to an embodiment of the present invention may comprise padding a motion compensation padding area within a first padding distance from a boundary of a current picture according to a motion vector of a boundary block adjacent to the boundary of the current picture, padding a repetitive padding area within a second padding area from a boundary of the motion compensation padding area according to a value of a pixel adjacent to the boundary of the motion compensation padding area, and storing an extended picture composed of the current picture, the motion compensation padding area and the repetitive padding area in a memory.

### MODE FOR INVENTION

The present invention may have various modifications and embodiments, and specific embodiments are illustrated in the drawings and described in detail in the detailed description. However, this is not intended to limit the present invention to specific embodiments, but should be understood to include all modifications, equivalents, or substitutes included in the spirit and technical scope of the present invention. Similar reference numerals in the drawings indicate the same or similar functions throughout various aspects. The shapes and sizes of elements in the drawings may be provided by way of example for a clearer description. The detailed description of the exemplary embodiments described below refers to the accompanying drawings, which illustrate specific embodiments by way of example. These embodiments are described in sufficient detail to enable those skilled in the art to practice the embodiments. It should be understood that the various embodiments are different from each other, but are not necessarily mutually exclusive. For example, specific shapes, structures, and characteristics described herein may be implemented in other embodiments without departing from the spirit and scope of the present invention with respect to one embodiment. It should also be understood that the positions or arrangements of individual components within each disclosed embodiment may be changed without departing from the spirit and scope of the embodiment. Accordingly, the detailed description set forth below is not intended to be limiting, and the scope of the exemplary embodiments is defined only by the appended claims, along with the full scope of equivalents to which such claims are entitled, if properly described.

In the present invention, the terms first, second, etc. may be used to describe various components, but the components should not be limited by the terms. The terms are only used for the purpose of distinguishing one component from another. For example, without departing from the scope of the present invention, the first component may be referred to as the second component, and similarly, the second component may also be referred to as the first component. The term and/or includes a combination of a plurality of related described items or any item among a plurality of related described items.

The components shown in the embodiments of the present invention are independently depicted to indicate different characteristic functions, and do not mean that each component is formed as a separate hardware or software configuration unit. That is, each component is listed and included as a separate component for convenience of explanation, and at least two of the components may be combined to form a single component, or one component may be divided into multiple components to perform a function, and embodiments in which components are integrated and embodiments in which each component is divided are also included in the scope of the present invention as long as they do not deviate from the essence of the present invention.

The terminology used in the present invention is only used to describe specific embodiments and is not intended to limit the present invention. The singular expression includes the plural expression unless the context clearly indicates otherwise. In addition, some components of the present invention are not essential components that perform essential functions in the present invention and may be optional components only for improving performance. The present invention may be implemented by including only essential components for implementing the essence of the present invention excluding components only used for improving performance, and a structure including only essential components excluding optional components only used for improving performance is also included in the scope of the present invention.

In an embodiment, the term “at least one” may mean one of a number greater than or equal to 1, such as 1, 2, 3, and 4. In an embodiment, the term “a plurality of” may mean one of a number greater than or equal to 2, such as 2, 3, and 4.

Hereinafter, embodiments of the present invention will be specifically described with reference to the drawings. In describing the embodiments of this specification, if it is determined that a detailed description of a related known configuration or function may obscure the subject matter of this specification, the detailed description will be omitted, and the same reference numerals will be used for the same components in the drawings, and repeated descriptions of the same components will be omitted.

### Description of Terms

Hereinafter, “image” may mean one picture constituting a video, and may also refer to the video itself. For example, “encoding and/or decoding of an image” may mean “encoding and/or decoding of a video,” and may also mean “encoding and/or decoding of one of images constituting the video.”

Hereinafter, “moving image” and “video” may be used with the same meaning and may be used interchangeably. In addition, a target image may be an encoding target image that is a target of encoding and/or a decoding target image that is a target of decoding. In addition, the target image may be an input image input to an encoding apparatus and may be an input image input to a decoding apparatus. Here, the target image may have the same meaning as a current image.

Hereinafter, “image”, “picture”, “frame” and “screen” may be used with the same meaning and may be used interchangeably.

Hereinafter, a “target block” may be an encoding target block that is a target of encoding and/or a decoding target block that is a target of decoding. In addition, the target block may be a current block that is a target of current encoding and/or decoding. For example, “target block” and “current block” may be used with the same meaning and may be used interchangeably.

Hereinafter, “block” and “unit” may be used with the same meaning and may be used interchangeably. In addition, “unit” may mean including a luma component block and a chroma component block corresponding thereto in order to distinguish it from a block. For example, a coding tree unit (CTU) may be composed of one luma component (Y) coding tree block (CTB) and two chroma component (Cb, Cr) coding tree blocks related to it.

Hereinafter, “sample”, “picture element” and “pixel” may be used with the same meaning and may be used interchangeably. Herein, a sample may represent a basic unit that constitutes a block.

Hereinafter, “inter” and “inter-screen” may be used with the same meaning and can be used interchangeably.

Hereinafter, “intra” and “in-screen” may be used with the same meaning and can be used interchangeably.

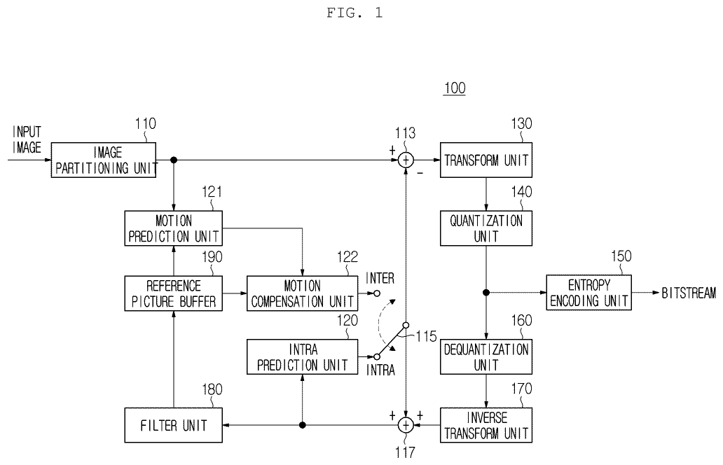

FIG. 1 is a block diagram showing a configuration of an encoding apparatus according to an embodiment of the present invention.

The encoding apparatus 100 may be an encoder, a video encoding apparatus, or an image encoding apparatus. A video may include one or more images. The encoding apparatus 100 may sequentially encode one or more images.

Referring to FIG. 1, the encoding apparatus 100 may include an image partitioning unit 110, an intra prediction unit 120, a motion prediction unit 121, a motion compensation unit 122, a switch 115, a subtractor 125, a transform unit 130, a quantization unit 140, an entropy encoding unit 150, a dequantization unit 160, an inverse transform unit 170, an adder 117, a filter unit 180 and a reference picture buffer 190.

In addition, the encoding apparatus 100 may generate a bitstream including information encoded through encoding of an input image, and output the generated bitstream. The generated bitstream may be stored in a computer-readable recording medium, or may be streamed through a wired/wireless transmission medium.

The image partitioning unit 110 may partition the input image into various forms to increase the efficiency of video encoding/decoding. That is, the input video is composed of multiple pictures, and one picture may be hierarchically partitioned and processed for compression efficiency, parallel processing, etc. For example, one picture may be partitioned into one or multiple tiles or slices, and then partitioned again into multiple CTUs (Coding Tree Units). Alternatively, one picture may first be partitioned into multiple sub-pictures defined as groups of rectangular slices, and each sub-picture may be partitioned into the tiles/slices. Here, the sub-picture may be utilized to support the function of partially independently encoding/decoding and transmitting the picture. Since multiple sub-pictures may be individually reconstructed, it has the advantage of easy editing in applications that configure multi-channel inputs into one picture. In addition, a tile may be divided horizontally to generate bricks. Here, the brick may be utilized as the basic unit of parallel processing within the picture. In addition, one CTU may be recursively partitioned into quad trees (QTs), and the terminal node of the partition may be defined as a CU (Coding Unit). The CU may be partitioned into a PU (Prediction Unit), which is a prediction unit, and a TU (Transform Unit), which is a transform unit, to perform prediction and partition. Meanwhile, the CU may be utilized as the prediction unit and/or the transform unit itself. Here, for flexible partition, each CTU may be recursively partitioned into multi-type trees (MTTs) as well as quad trees (QTs). The partition of the CTU into multi-type trees may start from the terminal node of the QT, and the MTT may be composed of a binary tree (BT) and a triple tree (TT). For example, the MTT structure may be classified into a vertical binary split mode (SPLIT_BT_VER), a horizontal binary split mode (SPLIT_BT_HOR), a vertical ternary split mode (SPLIT_TT_VER), and a horizontal ternary split mode (SPLIT_TT_HOR). In addition, a minimum block size (MinQTSize) of the quad tree of the luma block during partition may be set to 16×16, a maximum block size (MaxBtSize) of the binary tree may be set to 128×128, and a maximum block size (MaxTtSize) of the triple tree may be set to 64×64. In addition, a minimum block size (MinBtSize) of the binary tree and a minimum block size (MinTtSize) of the triple tree may be specified as 4×4, and the maximum depth (MaxMttDepth) of the multi-type tree may be specified as 4. In addition, in order to increase the encoding efficiency of the I slice, a dual tree that differently uses CTU partition structures of luma and chroma components may be applied. The above quad-tree structure may include a rectangular quad-tree structure and a triangular quad-tree tree structure to which geometric partitioning is applied. And the above ternary tree structure may include a rectangular ternary tree structure and an asymmetric ternary tree structure to which geometric partitioning is applied. The above binary tree structure may include a rectangular binary tree structure and a geometric binary tree structure to which geometric partitioning is applied. On the other hand, in P and B slices, the luma and chroma CTBs (Coding Tree Blocks) within the CTU may be partitioned into a single tree that shares the coding tree structure.

The encoding apparatus 100 may perform encoding on the input image in the intra mode and/or the inter mode. Alternatively, the encoding apparatus 100 may perform encoding on the input image in a third mode (e.g., IBC mode, Palette mode, etc.) other than the intra mode and the inter mode. However, if the third mode has functional characteristics similar to the intra mode or the inter mode, it may be classified as the intra mode or the inter mode for convenience of explanation. In the present invention, the third mode will be classified and described separately only when a specific description thereof is required.

When the intra mode is used as the prediction mode, the switch 115 may be switched to intra, and when the inter mode is used as the prediction mode, the switch 115 may be switched to inter. Here, the intra mode may mean an intra prediction mode, and the inter mode may mean an inter prediction mode. The encoding apparatus 100 may generate a prediction block for an input block of the input image. In addition, the encoding apparatus 100 may encode a residual block using a residual of the input block and the prediction block after the prediction block is generated. The input image may be referred to as a current image which is a current encoding target. The input block may be referred to as a current block which is a current encoding target or an encoding target block.

When a prediction mode is an intra mode, the intra prediction unit 120 may use a sample of a block that has been already encoded/decoded around a current block as a reference sample. The intra prediction unit 120 may perform spatial prediction for the current block by using the reference sample, or generate prediction samples of an input block through spatial prediction. Herein, the intra prediction may mean intra prediction.

As an intra prediction method, non-directional prediction modes such as DC mode and Planar mode and directional prediction modes (e.g., 65 directions) may be applied. Here, the intra prediction method may be expressed as an intra prediction mode or an intra prediction mode.

When a prediction mode is an inter mode, the motion prediction unit 111 may retrieve a region that best matches with an input block from a reference image in a motion prediction process, and derive a motion vector by using the retrieved region. In this case, a search region may be used as the region. The reference image may be stored in the reference picture buffer 190. Here, when encoding/decoding for the reference image is performed, it may be stored in the reference picture buffer 190.

The motion compensation unit 112 may generate a prediction block of the current block by performing motion compensation using a motion vector. Herein, inter prediction may mean inter prediction or motion compensation.

When the value of the motion vector is not an integer, the motion prediction unit 111 and the motion compensation unit 112 may generate the prediction block by applying an interpolation filter to a partial region of the reference picture. In order to perform inter prediction or motion compensation, it may be determined whether the motion prediction and motion compensation mode of the prediction unit included in the coding unit is one of a skip mode, a merge mode, an advanced motion vector prediction (AMVP) mode, and an intra block copy (IBC) mode based on the coding unit and inter prediction or motion compensation may be performed according to each mode.

In addition, based on the above inter prediction method, an AFFINE mode of sub-PU based prediction, an SbTMVP (Subblock-based Temporal Motion Vector Prediction) mode, an MMVD (Merge with MVD) mode of PU-based prediction, and a GPM (Geometric Partitioning Mode) mode may be applied. In addition, in order to improve the performance of each mode, HMVP (History based MVP), PAMVP (Pairwise Average MVP), CIIP (Combined Intra/Inter Prediction), AMVR (Adaptive Motion Vector Resolution), BDOF (Bi-Directional Optical-Flow), BCW (Bi-predictive with CU Weights), LIC (Local Illumination Compensation), TM (Template Matching), OBMC (Overlapped Block Motion Compensation), etc. may be applied.

The subtractor 113 may generate a residual block by using a difference between an input block and a prediction block. The residual block may be called a residual signal. The residual signal may mean a difference between an original signal and a prediction signal. Alternatively, the residual signal may be a signal generated by transforming or quantizing, or transforming and quantizing a difference between the original signal and the prediction signal. The residual block may be a residual signal of a block unit.

The transform unit 130 may generate a transform coefficient by performing transform on a residual block, and output the generated transform coefficient. Herein, the transform coefficient may be a coefficient value generated by performing transform on the residual block. When a transform skip mode is applied, the transform unit 130 may skip transform of the residual block.

A quantized level may be generated by applying quantization to the transform coefficient or to the residual signal. Hereinafter, the quantized level may also be called a transform coefficient in embodiments.

For example, a 4×4 luma residual block generated through intra prediction is transformed using a base vector based on DST (Discrete Sine Transform), and transform may be performed on the remaining residual block using a base vector based on DCT (Discrete Cosine Transform). In addition, a transform block is partitioned into a quad tree shape for one block using RQT (Residual Quad Tree) technology, and after performing transform and quantization on each transformed block partitioned through RQT, a coded block flag (cbf) may be transmitted to increase encoding efficiency when all coefficients become 0.

As another alternative, the Multiple Transform Selection (MTS) technique, which selectively uses multiple transform bases to perform transform, may be applied. That is, instead of partitioning a CU into TUs through RQT, a function similar to TU partition may be performed through the sub-block Transform (SBT) technique. Specifically, SBT is applied only to inter prediction blocks, and unlike RQT, the current block may be partitioned into ½ or ¼ sizes in the vertical or horizontal direction and then transform may be performed on only one of the blocks. For example, if it is partitioned vertically, transform may be performed on the leftmost or rightmost block, and if it is partitioned horizontally, transform may be performed on the topmost or bottommost block.

In addition, LFNST (Low Frequency Non-Separable Transform), a secondary transform technique that additionally transforms the residual signal transformed into the frequency domain through DCT or DST, may be applied. LFNST additionally performs transform on the low-frequency region of 4×4 or 8×8 in the upper left, so that the residual coefficients may be concentrated in the upper left.

The quantization unit 140 may generate a quantized level by quantizing the transform coefficient or the residual signal according to a quantization parameter (QP), and output the generated quantized level. Herein, the quantization unit 140 may quantize the transform coefficient by using a quantization matrix.

For example, a quantizer using QP values of 0 to 51 may be used. Alternatively, if the image size is larger and high encoding efficiency is required, the QP of 0 to 63 may be used. Also, a DQ (Dependent Quantization) method using two quantizers instead of one quantizer may be applied. DQ performs quantization using two quantizers (e.g., Q0 and Q1), but even without signaling information about the use of a specific quantizer, the quantizer to be used for the next transform coefficient may be selected based on the current state through a state transition model.

The entropy encoding unit 150 may generate a bitstream by performing entropy encoding according to a probability distribution on values calculated by the quantization unit 140 or on coding parameter values calculated when performing encoding, and output the bitstream. The entropy encoding unit 150 may perform entropy encoding of information on a sample of an image and information for decoding an image. For example, the information for decoding the image may include a syntax element.

When entropy encoding is applied, symbols are represented so that a smaller number of bits are assigned to a symbol having a high occurrence probability and a larger number of bits are assigned to a symbol having a low occurrence probability, and thus, the size of bit stream for symbols to be encoded may be decreased. The entropy encoding unit 150 may use an encoding method, such as exponential Golomb, context-adaptive variable length coding (CAVLC), context-adaptive binary arithmetic coding (CABAC), etc., for entropy encoding. For example, the entropy encoding unit 150 may perform entropy encoding by using a variable length coding/code (VLC) table. In addition, the entropy encoding unit 150 may derive a binarization method of a target symbol and a probability model of a target symbol/bin, and perform arithmetic coding by using the derived binarization method, and a context model.

In relation to this, when applying CABAC, in order to reduce the size of the probability table stored in the decoding apparatus, a table probability update method may be changed to a table update method using a simple equation and applied. In addition, two different probability models may be used to obtain more accurate symbol probability values.

In order to encode a transform coefficient level (quantized level), the entropy encoding unit 150 may change a two-dimensional block form coefficient into a one-dimensional vector form through a transform coefficient scanning method.

A coding parameter may include information (flag, index, etc.) encoded in the encoding apparatus 100 and signaled to the decoding apparatus 200, such as syntax element, and information derived in the encoding or decoding process, and may mean information required when encoding or decoding an image.

Herein, signaling the flag or index may mean that a corresponding flag or index is entropy encoded and included in a bitstream in an encoder, and may mean that the corresponding flag or index is entropy decoded from a bitstream in a decoder.

The encoded current image may be used as a reference image for another image to be processed later. Therefore, the encoding apparatus 100 may reconstruct or decode the encoded current image again and store the reconstructed or decoded image as a reference image in the reference picture buffer 190.

A quantized level may be dequantized in the dequantization unit 160, or may be inversely transformed in the inverse transform unit 170. A dequantized and/or inversely transformed coefficient may be added with a prediction block through the adder 117. Herein, the dequantized and/or inversely transformed coefficient may mean a coefficient on which at least one of dequantization and inverse transform is performed, and may mean a reconstructed residual block. The dequantization unit 160 and the inverse transform unit 170 may be performed as an inverse process of the quantization unit 140 and the transform unit 130.

The reconstructed block may pass through the filter unit 180. The filter unit 180 may apply a deblocking filter, a sample adaptive offset (SAO), an adaptive loop filter (ALF), a bilateral filter (BIF), luma mapping with chroma scaling (LMCS), etc. to a reconstructed sample, a reconstructed block or a reconstructed image using all or some filtering techniques. The filter unit 180 may be called an in-loop filter. In this case, the in-loop filter is also used as name excluding LMCS.

The deblocking filter may remove block distortion generated in boundaries between blocks. In order to determine whether or not to apply a deblocking filter, whether or not to apply a deblocking filter to a current block may be determined based on samples included in several rows or columns which are included in the block. When a deblocking filter is applied to a block, a different filter may be applied according to a required deblocking filtering strength.

In order to compensate for encoding error using sample adaptive offset, a proper offset value may be added to a sample value. The sample adaptive offset may correct an offset of a deblocked image from an original image by a sample unit. A method of partitioning a sample included in an image into a predetermined number of regions, determining a region to which an offset is applied, and applying the offset to the determined region, or a method of applying an offset in consideration of edge information on each sample may be used.

A bilateral filter (BIF) may also correct the offset from the original image on a sample-by-sample basis for the image on which deblocking has been performed.

The adaptive loop filter may perform filtering based on a comparison result of the reconstructed image and the original image. Samples included in an image may be partitioned into predetermined groups, a filter to be applied to each group may be determined, and differential filtering may be performed for each group. Information of whether or not to apply the ALF may be signaled by coding units (CUs), and a form and coefficient of the adaptive loop filter to be applied to each block may vary.

In LMCS (Luma Mapping with Chroma Scaling), luma mapping (LM) means remapping luma values through a piece-wise linear model, and chroma scaling (CS) means a technique for scaling the residual value of the chroma component according to the average luma value of the prediction signal. In particular, LMCS may be utilized as an HDR correction technique that reflects the characteristics of HDR (High Dynamic Range) images.

The reconstructed block or the reconstructed image having passed through the filter unit 180 may be stored in the reference picture buffer 190. A reconstructed block that has passed through the filter unit 180 may be a part of a reference image. That is, the reference image is a reconstructed image composed of reconstructed blocks that have passed through the filter unit 180. The stored reference image may be used later in inter prediction or motion compensation.

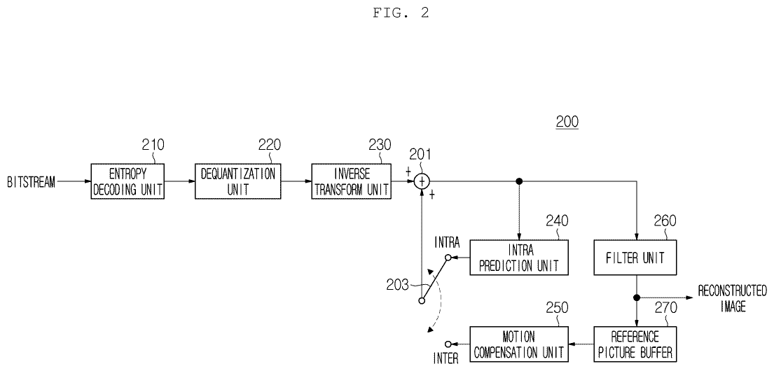

FIG. 2 is a block diagram showing a configuration of a decoding apparatus according to an embodiment of the present invention.

A decoding apparatus 200 may a decoder, a video decoding apparatus, or an image decoding apparatus.

Referring to FIG. 2, the decoding apparatus 200 may include an entropy decoding unit 210, a dequantization unit 220, an inverse transform unit 230, an intra prediction unit 240, a motion compensation unit 250, an adder 201, a switch 203, a filter unit 260, and a reference picture buffer 270.

The decoding apparatus 200 may receive a bitstream output from the encoding apparatus 100. The decoding apparatus 200 may receive a bitstream stored in a computer-readable recording medium, or may receive a bitstream that is streamed through a wired/wireless transmission medium. The decoding apparatus 200 may decode the bitstream in an intra mode or an inter mode. In addition, the decoding apparatus 200 may generate a reconstructed image generated through decoding or a decoded image, and output the reconstructed image or decoded image.

When a prediction mode used for decoding is an intra mode, the switch 20 may be switched to intra. Alternatively, when a prediction mode used for decoding is an inter mode, the switch 203 may be switched to inter.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block and the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be an inverse process of the entropy encoding method described above.

The entropy decoding unit 210 may change a one-dimensional vector-shaped coefficient into a two-dimensional block-shaped coefficient through a transform coefficient scanning method to decode a transform coefficient level (quantized level).

A quantized level may be dequantized in the dequantization unit 220, or inversely transformed in the inverse transform unit 230. The quantized level may be a result of dequantization and/or inverse transform, and may be generated as a reconstructed residual block. Herein, the dequantization unit 220 may apply a quantization matrix to the quantized level. The dequantization unit 220 and the inverse transform unit 230 applied to the decoding apparatus may apply the same technology as the dequantization unit 160 and inverse transform unit 170 applied to the aforementioned encoding apparatus.

When an intra mode is used, the intra prediction unit 240 may generate a prediction block by performing, on the current block, spatial prediction that uses a sample value of a block which has been already decoded around a decoding target block. The intra prediction unit 240 applied to the decoding apparatus may apply the same technology as the intra prediction unit 120 applied to the aforementioned encoding apparatus.

When an inter mode is used, the motion compensation unit 250 may generate a prediction block by performing, on the current block, motion compensation that uses a motion vector and a reference image stored in the reference picture buffer 270. The motion compensation unit 250 may generate a prediction block by applying an interpolation filter to a partial region within a reference image when the value of the motion vector is not an integer value. In order to perform motion compensation, it may be determined whether the motion compensation method of the prediction unit included in the corresponding coding unit is a skip mode, a merge mode, an AMVP mode, or a current picture reference mode based on the coding unit, and motion compensation may be performed according to each mode. The motion compensation unit 250 applied to the decoding apparatus may apply the same technology as the motion compensation unit 122 applied to the encoding apparatus described above.

The adder 201 may generate a reconstructed block by adding the reconstructed residual block and the prediction block. The filter unit 260 may apply at least one of inverse-LMCS, a deblocking filter, a sample adaptive offset, and an adaptive loop filter to the reconstructed block or reconstructed image. The filter unit 260 applied to the decoding apparatus may apply the same filtering technology as that applied to the filter unit 180 applied to the aforementioned encoding apparatus.

The filter unit 260 may output the reconstructed image. The reconstructed block or reconstructed image may be stored in the reference picture buffer 270 and used for inter prediction. A reconstructed block that has passed through the filter unit 260 may be a part of a reference image. That is, a reference image may be a reconstructed image composed of reconstructed blocks that have passed through the filter unit 260. The stored reference image may be used later in inter prediction or motion compensation.

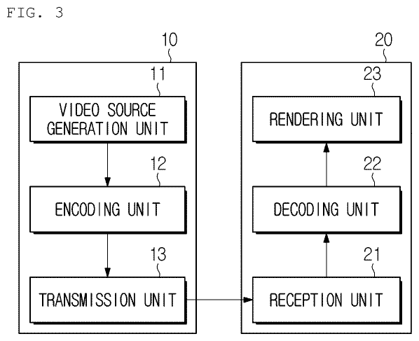

FIG. 3 is a diagram schematically showing a video coding system to which the present invention is applicable.

A video coding system according to an embodiment may include an encoding apparatus 10 and a decoding apparatus 20. The encoding apparatus 10 may transmit encoded video and/or image information or data to the decoding apparatus 20 in the form of a file or streaming through a digital storage medium or a network.

The encoding apparatus 10 according to an embodiment may include a video source generation unit 11, an encoding unit 12, a transmission unit 13. The decoding apparatus 20 according to an embodiment may include a reception unit 21, a decoding unit 22, and a rendering unit 23. The encoding unit 12 may be called a video/image encoding unit, and the decoding unit 22 may be called a video/image decoding unit. The transmission unit 13 may be included in the encoding unit 12. The reception unit 21 may be included in the decoding unit 22. The rendering unit 23 may include a display unit, and the display unit may be configured as a separate device or an external component.

The video source generation unit 11 may obtain the video/image through a process of capturing, synthesizing, or generating the video/image. The video source generation unit 11 may include a video/image capture device and/or a video/image generation device. The video/image capture device may include, for example, one or more cameras, a video/image archive including previously captured video/image, etc. The video/image generation device may include, for example, a computer, a tablet, and a smartphone, etc., and may (electronically) generate the video/image. For example, a virtual video/image may be generated through a computer, etc., in which case the video/image capture process may be replaced with a process of generating related data.

The encoding unit 12 may encode the input video/image. The encoding unit 12 may perform a series of procedures such as prediction, transform, and quantization for compression and encoding efficiency. The encoding unit 12 may output encoded data (encoded video/image information) in the form of a bitstream. The detailed configuration of the encoding unit 12 may also be configured in the same manner as the encoding apparatus 100 of FIG. 1 described above.

The transmission unit 13 may transmit encoded video/image information or data output in the form of a bitstream to the reception unit 21 of the decoding apparatus through a digital storage medium or a network in the form of a file or streaming. The digital storage medium may include various storage media such as USB, SD, CD, DVD, Blu-ray, HDD, SSD, etc. The transmission unit 13 may include an element for generating a media file through a predetermined file format and may include an element for transmission through a broadcasting/communication network. The reception unit 21 may extract/receive the bitstream from the storage medium or the network and transmit it to the decoding unit 22.

The decoding unit 22 may decode the video/image by performing a series of procedures such as dequantization, inverse transform, and prediction corresponding to the operation of the encoding unit 12. The detailed configuration of the decoding unit 22 may also be configured in the same manner as the above-described decoding apparatus 200 of FIG. 2.

The rendering unit 23 may render the decoded video/image. The rendered video/image may be displayed through the display unit.

In the present invention, a boundary area padding technique is proposed, which extends a reference picture using a padding method in a boundary area during motion compensation through motion prediction, and then generates an inter prediction block based on the extended reference picture. The boundary area padding method may be burdensome to a decoder due to high complexity and large memory usage. Therefore, a method that can pad a boundary area with low decoder complexity and small memory usage is proposed. In addition, various embodiments of a motion compensation method when a padded boundary area is referenced in bilateral motion compensation are proposed.

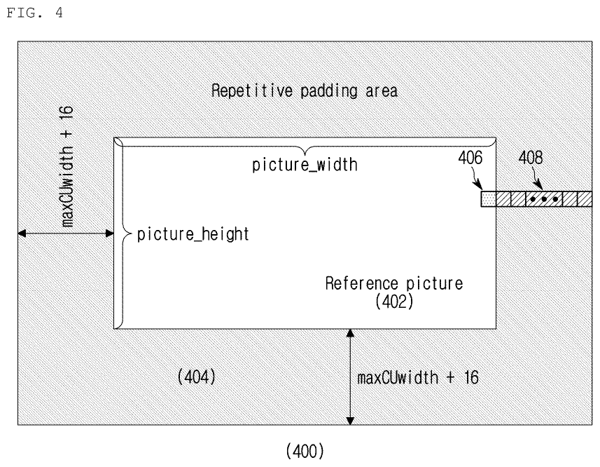

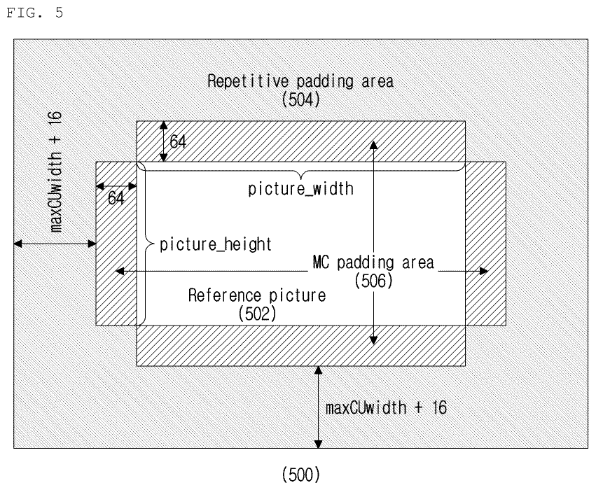

Hereinafter, FIG. 4 describes a method of determining an extended picture according to a repetitive padding method. In addition, FIGS. 5 to 8 describe a method of determining an extended picture according to a motion compensation padding method and a repetitive padding method.

FIG. 4 shows an embodiment of an extended picture generated according to a repetitive padding method.

FIG. 4 shows an extended picture 400 composed of a reference picture 402 and an extended picture area 404. Here, the extended picture area 404 means an area extended from the boundary of the reference picture 402 by a predetermined padding distance. The predetermined padding distance may be determined according to a maximum width of a coding unit and/or a maximum height of the coding unit. Alternatively, the predetermined padding distance may be determined to be a value that is greater by a predetermined value than the maximum width of the coding unit or the maximum height of the coding unit. For example, as shown in FIG. 4, when the maximum width of the coding unit is maxCUwidth, the predetermined padding size may be (maxCUwidth+16).

The extended picture area 404 of FIG. 4 is only composed of a repetitive padding area. The repetitive padding area is generated by repetitively padding pixels located at the boundary of the reference picture. Therefore, all pixels generated by padding based on one pixel of the boundary of the reference picture 402 in the extended picture area 404 of FIG. 4 have the same value. For example, the values of the pixels 408 of the extended picture area 404 generated from the pixel 406 of the reference picture 402 may all be determined to be the same as the value of the pixel 406 of the reference picture 402.

FIG. 5 shows an embodiment of an extended picture generated according to repetitive padding and motion compensation padding.

The extended picture 500 of FIG. 5 is composed of a reference picture 502 and an extended picture area. In addition, the extended picture area is composed of a repetitive padding area 504 and a motion compensation (MC) padding area 506.

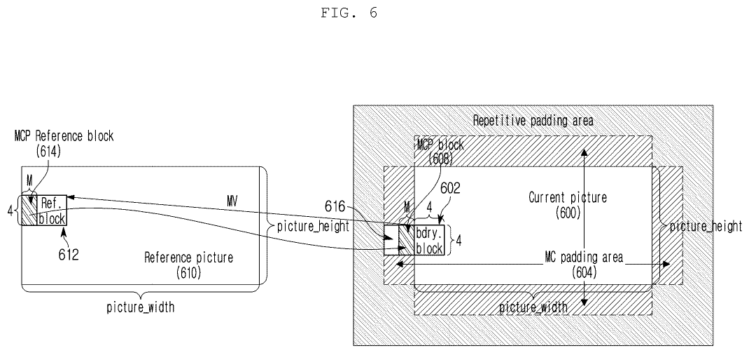

The pixels of the motion compensation padding area 506 are determined by motion compensation using a motion vector of a boundary block of the reference picture 502. The method of determining the motion compensation padding area 506 will be described in detail in FIG. 6. The area of the motion compensation padding area 506 may be determined by a first padding distance applied to the motion compensation padding area 506. For example, the area of the motion compensation padding area 506 may be determined by a product of the width of the reference picture 502 (picture_width) and the first padding distance and a product of the height of the reference picture 502 (picture_height) and the first padding distance.

The first padding distance may be determined by the height or width of the reference picture 502. Alternatively, the first padding distance may be a fixed value. For example, as shown in FIG. 5, the predetermined value may be 64. Accordingly, the size of the motion compensation padding area adjacent to the upper and lower boundaries of the reference picture may be (picture_width×64), and the size of the motion compensation padding area adjacent to the left and right boundaries of the reference picture may be (64×picture_height). According to an embodiment, the first padding distance applied to the motion compensation padding area 506 adjacent to the left and right sides of the reference picture 502 and the first padding distance applied to the motion compensation padding area 506 adjacent to the upper and lower sides of the reference picture 502 may be different from each other.

The repetitive padding area 504 is generated by repeatedly padding pixels located at the boundary of the reference picture 502 or the motion compensation padding area by a second padding distance. The second padding distance may be determined according to a maximum width of the coding unit and/or a maximum height of the coding unit. Alternatively, the second padding distance may be determined to be a value that is larger than the maximum width of the coding unit or the maximum height of the coding unit by a predetermined value. For example, as shown in FIG. 5, when the maximum width of the coding unit is maxCUwidth, the predetermined second padding distance may be (maxCUwidth+16).

The motion compensation padding area may be generated when a specific condition is satisfied. For example, the motion compensation padding area 506 may be determined according to a slice type of the current picture 502. If the slice type of the current picture 502 is an I slice, the motion compensation padding area 506 is not generated, and if it is a P or B slice, the motion compensation padding area 506 may be generated.

FIG. 6 shows an embodiment of a method of determining a motion compensation padding area.

A motion compensation padding area 604 of a current picture 600 is determined using a motion vector derived from a boundary block 602 with a predetermined size located at the boundary of the current picture 600. Using the motion vector, a reference block 612 corresponding to the boundary block 602 is determined from a reference picture 610 referenced for reconstruction of the current picture. When the reference block 612 is determined, a motion compensation padding block 608 is derived from a motion compensation padding reference block 614 on the left side of the reference block 612.

In FIG. 6, in order to determine the left part of the motion compensation padding area 604 of the current picture 600, the motion compensation padding reference block 614 on the left side of the reference block 612 is referenced. However, if it is necessary to determine the upper, lower or right motion compensation padding area, the block on the upper, lower or right side of the reference block of the reference picture 610 may be referenced.

The size of boundary block 602 may be set differently depending on the embodiment. In FIG. 6, the size of boundary block 602 is set to 4×4. Also, depending on the embodiment, the size of boundary block 602 may be set to the minimum size of the block determined by the encoder or decoder.

The size of the motion compensation padding block 608 is the same as the size of the motion compensation padding reference block 614 on the left side of the reference block 612. In FIG. 6, since only pixels within a distance of M pixels from the left side of the reference block 612 are available, the size of the motion compensation padding reference block 614 is set to M×4. Accordingly, the size of the motion compensation padding reference block 614 may be determined depending on how far away the available pixels are from the left side of the reference block 612.

However, the width of the motion compensation padding block 608 cannot be larger than the width of the left part of the motion compensation padding area 604. For example, if the motion compensation padding area is determined to be an area within a distance of 64 pixels from the reference picture as in FIG. 5, the width of the motion compensation padding block 608 is determined to be equal to or less than 64.

As with the left side, the motion compensation padding reference block of the motion compensation padding area on the right side may be set to M×4. In addition, the motion compensation padding reference blocks of the motion compensation padding areas on the upper and lower sides may be set to 4×M.

If the boundary block 602 is reconstructed by bi-prediction, two motion vectors may be derived from the boundary block 602. Therefore, two reference blocks for motion compensation padding may be derived from the two motion vectors. In addition, based on the two reference blocks, the motion compensation padding block 608 may be determined.

According to one embodiment, a larger motion compensation padding reference block among two motion compensation padding reference blocks derived from the two motion vectors may be determined to be the motion compensation padding block 608. Alternatively, a motion compensation padding reference block of a reference block existing in a picture closer to the current picture 600 may be determined to be the motion compensation padding block 608.

Alternatively, a block determined by averaging two motion compensation padding reference blocks may be determined to be the motion compensation padding block 608. Alternatively, a block determined by a weighted average of two motion compensation padding reference blocks may be determined to be the motion compensation padding block 608. In this case, the weight used in the weighted average may be determined according to a POC (Picture Order Count) distance between reference pictures.

According to FIG. 5, the sizes of the motion compensation padding areas on the upper and lower sides are determined to be (picture_width×64), respectively, and the sizes of the motion compensation padding areas on the left and right sides are determined to be (64×picture_height), respectively. According to FIG. 6, the sizes of the motion compensation padding blocks on the upper and lower sides are determined to be 4×M, and the sizes of the motion compensation padding blocks on the left and right sides are determined to be M×4. Due to the first padding distance defined for the motion compensation padding block, the maximum value of M is determined to be the first padding distance.

Depending on embodiments, the first padding distance is shown as 64 in FIG. 5. However, the first padding distance may have a value other than 64, such as 8, 16, 32, 128, or 256. As the distance from the reference picture increases, the prediction accuracy of the motion vector extracted from the boundary block decreases. Therefore, the first padding distance may be determined within a range in which the prediction accuracy of inter prediction can be improved.

According to an embodiment, the first padding distance may be determined according to the maximum width or maximum height of the coding unit. For example, the first padding distance may be determined to be a value equal to the maximum width or maximum height of the coding unit. Alternatively, the first padding distance may be determined by multiplying or dividing the maximum width or maximum height of the coding unit by a predetermined value.

According to an embodiment, the first padding distance may be determined based on the size of the reference picture. For example, as the size of the reference picture increases, the first padding distance may increase. Conversely, as the size of the reference picture decreases, the first padding distance may decrease.

According to an embodiment, the first padding distance may be determined according to the size of a boundary block that serves as a reference for motion compensation padding. According to FIG. 6, the size of the boundary block 602 is defined as 4×4, and the padding distance of motion compensation padding area 604 is defined as 64. However, if the size of the boundary block increases, the padding distance of the motion compensation padding area may also increase.

According to an embodiment, the first padding distance may be determined from a slice header or a picture header. The slice header or the picture header may include information indicating the first padding distance, or may reference a parameter set including the information. The parameter set may include a video parameter set, a sequence parameter set, or a picture parameter set.

If the value of M is smaller than the first padding distance, the motion compensation padding area from (M+1) to the first padding distance may be determined by repeatedly padding the value of the pixel located at the outermost edge in the corresponding direction in the current picture. For example, the motion compensation padding area 616 may be determined by the current picture 600.

Alternatively, the motion compensation padding area may be determined by repeatedly padding the value of the pixel located at the outermost edge in the corresponding direction in the motion compensation padding block. For example, the motion compensation padding area 616 may be determined by the motion compensation padding block 608 determined by the motion compensation padding.

If boundary block 602 is encoded/decoded in the intra prediction mode or the motion vector information of the boundary block 602 cannot be used, the value of M is set to 0, and padding of the motion compensation padding area 616 may be performed using a method applied to the repetitive padding area.

According to FIG. 5, the size of the motion compensation padding area is (picture_width×64) and (64×picture_height). Depending on embodiments, in order to reduce memory usage, the size of the motion compensation padding area may be determined according to an arbitrary integer N smaller than 64 (N≤64). Therefore, the size of the motion compensation padding area may be set to (picture_width×N) and (N×picture_height). At this time, the magnitude of N may be set to an arbitrary integer smaller than or equal to 64 (for example, 2, 4, 8, 16, 32, 64, etc.). The magnitude of M in the M×4 or 4×M motion compensation padding block may be determined based on the determined magnitude of N. For example, if the magnitude of N in the motion compensation padding area is determined to be 16, the magnitude of M of the motion compensation padding block may be determined to be equal to or smaller than 16. That is, M≤N may be set.

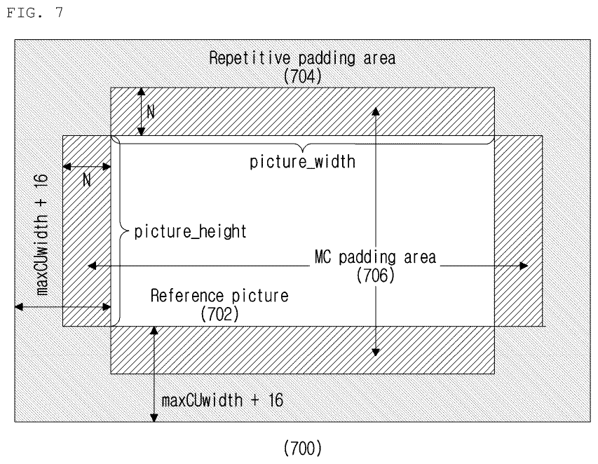

FIG. 7 shows an embodiment of an extended picture in which an extended picture area is determined regardless of the size of a motion compensation padding area.

According to FIG. 4, the extended picture area includes only a repetitive padding area. In addition, the extended picture area is generated by extending the reference picture by pixels of the second padding distance (maxCUwidth+16) from the boundary of the reference picture in each direction. On the other hand, according to FIG. 5, the extended picture area includes a repetitive padding area and a motion compensation padding area. In addition, the extended picture area is generated by extending the reference picture by pixels of a distance (maxCUwidth+16+N) corresponding to the sum of the first padding distance N and the second padding distance (maxCUwidth+16) from the boundary of the reference picture in each direction.

Therefore, when determining the extended picture area according to FIG. 5, N pixels are further extended from the reference picture in each direction from the boundary of the reference picture compared to when determining the extended picture area according to the embodiment of FIG. 4, so that the memory usage increases. Therefore, in order to reduce the memory usage, even when the motion compensation padding area is applied, the size of the extended picture area may be limited as illustrated in FIG. 4.

The size of the extended picture 700 according to FIG. 7 may be determined to be the same as the size of the extended picture 400 of FIG. 4. Accordingly, the sizes of the memory required for storing the extended picture 400 of FIG. 4 and the memory required for storing the extended picture 700 of FIG. 7 are determined to be the same.

In FIG. 5, the motion compensation padding area 506 is determined by a predetermined first padding distance, and the repetitive padding area 504 outside the motion compensation padding area 506 is determined by a predetermined second padding distance. Therefore, in the case of FIG. 5, the size of the extended picture 500 is determined by the sum of the first padding distance and the second padding distance. However, in the case of FIG. 7, the size of the extended picture 700 may be determined by the second padding distance regardless of the first padding distance.

Specifically, the motion compensation padding area 706 of FIG. 7 is determined according to the first padding distance. However, since the extended picture 700 is determined to be an area extended by the second padding distance from the reference picture 702, the repetitive padding area 704 is determined by a distance obtained by subtracting the first padding distance from the second padding distance.

According to FIG. 7, the first padding distance is defined as N, and the second padding distance is defined as (maxCUwidth+16). The first padding distance is set to be smaller than the second padding distance, so that N is set to be smaller than (maxCUwidth+16). Here, maxCUwidth represents the maximum width of the coding unit. The second padding distance may be determined to be the maximum width of the coding unit or the maximum height of the coding unit, or may be determined to be a larger value.

In conclusion, the size of the extended picture 700 may be determined according to the second padding distance, regardless of the first padding distance applied to the motion compensation padding area 706. Therefore, the size of the extended picture 700 and the size of the memory required for the extended picture 700 are fixed regardless of whether the motion compensation padding area 706 is applied and the first padding distance, so that the memory resources required for video encoding and decoding can be efficiently managed.

According to another embodiment, the second padding distance is not defined, and the extended picture 700 may be extended only by the first padding distance N from the reference picture 702. In this case, only the motion compensation padding area 706 may be determined on the upper, lower, left, and right sides of the extended picture 700. In addition, only the upper left, upper right, lower left, and lower right areas near the vertex of the extended picture 700 may be set as the repetitive padding area 704. Therefore, the extended picture 700 may be determined to be an area extended by the first padding distance from the reference picture 702.

In conclusion, the size of the extended picture 700 may be determined according to the first padding distance by omitting the generation of the repetitive padding area 704 according to the second padding distance. Therefore, in generating the extended picture 700, the second padding distance is not applied, and only the first padding distance is applied, so that the size of the extended picture 700 and the size of the memory required for the extended picture 700 may be fixed. As a result, the memory resources required for video encoding and decoding can be efficiently managed.

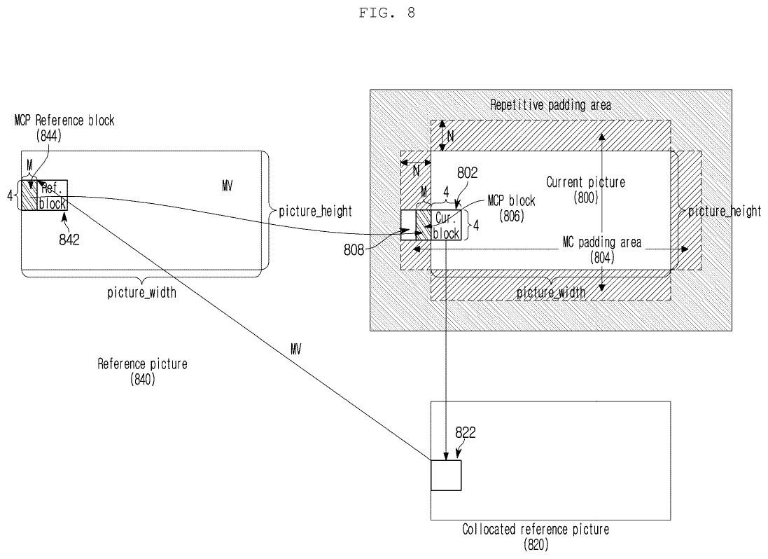

FIG. 8 shows an embodiment of a method of performing motion compensation padding based on temporal neighboring blocks.

In the motion compensation padding method of FIGS. 5 to 7, padding using motion compensation is impossible when a boundary block adjacent to the boundary of the current picture is encoded/decoded in an intra prediction mode or when motion vector information of the boundary block cannot be used. Accordingly, according to an embodiment, in the above case, since a reference block to be referenced in determining a motion compensation padding block cannot be determined, the motion compensation padding area may be padded according to a repetitive padding method.

In this case, since the motion compensation padding area is substantially determined by the repetitive padding method, the encoding efficiency may be likely to be lowered as the accuracy of the extended picture area is lowered. Therefore, according to an embodiment, when the boundary block is encoded/decoded in the intra prediction mode or the motion vector information of the boundary block is not available, the motion compensation padding block may be derived based on the temporal neighboring blocks of the boundary block.

According to FIG. 8, when a boundary block 802 adjacent to the boundary of a current picture 800 is encoded/decoded in an intra prediction mode, or when motion vector information of the boundary block 802 is not available, a temporal adjacent block 822 at the same spatial position as the boundary block 802 is determined in a temporal corresponding reference picture 820. Then, based on the motion vector of the temporal adjacent block 822, a corresponding reference block 842 is determined in the reference picture 840. Then, a motion compensation padding reference block 844 is derived on the left side of the reference block 842, and a motion compensation padding block 806 is determined based on the motion compensation padding reference block 844.

When the temporal adjacent block 822 is also encoded/decoded in the intra prediction mode, or when the motion vector information of the temporal adjacent block 822 is also unavailable, a reference block to be referenced in determining the motion compensation padding block 806 cannot be determined, so the motion compensation padding area may be padded according to the repetitive padding method. However, depending on embodiments, when the motion vector cannot be derived from the temporal adjacent block 822, a new temporal adjacent block may be derived from another temporal corresponding reference picture, and a motion compensation padding reference block 844 may be derived from the new temporal adjacent block.

In FIG. 8, the padding distance applied to the motion compensation padding area 804 is an arbitrary integer N, and the padding distance of the motion compensation padding block 806 is an arbitrary integer M. Here, M may be equal to or smaller than N. If the padding distance M of the motion compensation padding block 806 determined by the motion compensation padding reference block 844 is smaller than N, the remaining block 808 that is not padded by the motion compensation padding method may be padded by the repetitive padding method with reference to the pixels of the compensation padding block 806.

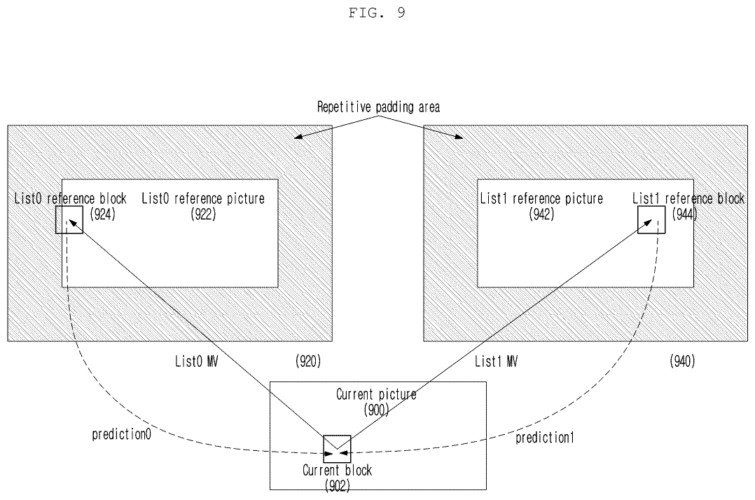

Hereinafter, FIGS. 9 to 11 illustrate embodiments of a method of performing bilateral motion prediction based on an extended picture determined based on a repetitive padding method.

FIG. 9 shows an embodiment of a block prediction method by bilateral motion prediction.

According to bilateral motion prediction, a prediction signal of a current block 902 is generated using two reference blocks 924 and 944 derived from different reference pictures 922 and 942 referenced by a current picture 900. Specifically, the prediction signal of the current block may be generated using a List0 reference block 924 derived from a List0 reference picture 922 and a List1 reference block 944 derived from a List1 reference picture 942.

According to FIG. 9, the List0 reference block 924 is partially outside the List0 reference picture 922 (out of boundary, OOB), while the List1 reference block 944 is completely inside the List1 reference picture 942 (non out of boundary, non-OOB).

When the extended picture areas 920 and 940 are determined using only the repetitive padding method, the prediction accuracy of the bilateral motion prediction method may be reduced when the reference block is partially or completely located outside the reference picture, as in FIG. 9. Therefore, various embodiments for improving the prediction accuracy of the bilateral motion prediction method in the above case are proposed.

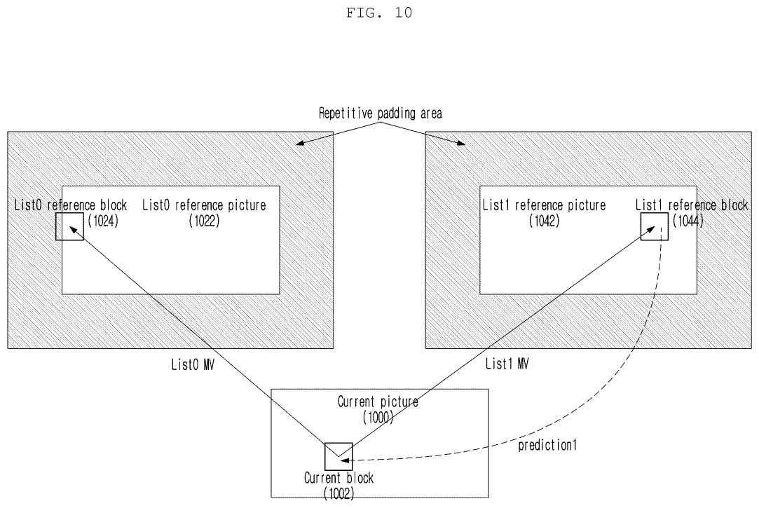

FIG. 10 illustrates an embodiment of a block prediction method by bilateral motion prediction when a part of a reference block is located outside a reference picture.

According to FIG. 10, when performing bilateral motion prediction, a List1 reference block 1044 is completely inside a List1 reference picture 1042, and a List0 reference block 1024 is partially outside a List0 reference picture 1022. At this time, a prediction block of a current block 1002 in a current picture 1000 may be generated only using the List1 reference block 1044 that is completely inside the reference picture. Conversely, if the List0 reference block 1024 is completely inside the List0 reference picture 1022, and the List1 reference block 1044 is partially outside the List1 reference picture 1042, the prediction block of the current block 1002 may be generated only using the List0 reference block 1024.

As in FIG. 10, by using only reference blocks that are fully included in the reference picture, reference blocks that include pixels in the repetitive padding area are excluded from motion prediction. Accordingly, as the repetitive padding area is excluded from the prediction process, the prediction accuracy of the current block can be improved.

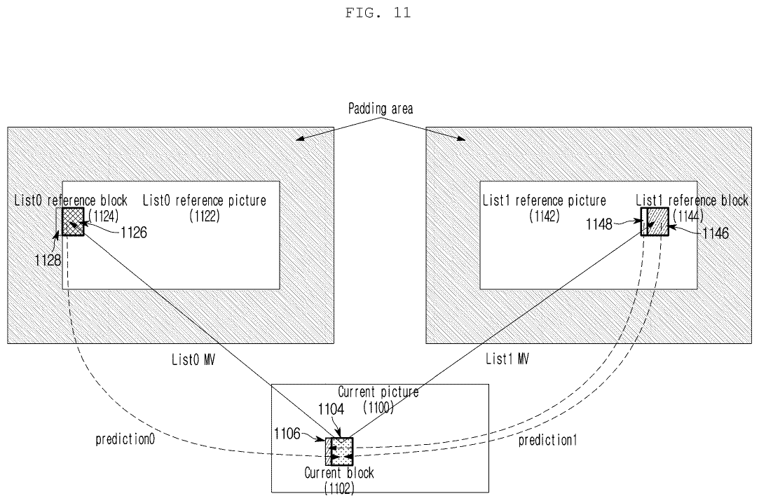

FIG. 11 illustrates an embodiment of a block prediction method by bilateral motion prediction when a part of a reference block is located outside a reference picture.

According to FIG. 11, when performing bilateral motion prediction, a List1 reference block 1144 is completely inside a List1 reference picture 1142, and a List0 reference block 1124 is partially outside a List0 reference picture 1122. At this time, all pixels of the List1 reference block 1144 that is completely inside the List1 reference picture 1142 may be referenced for generating the prediction block of the current block 1102. However, since a part of the List0 reference block 1124 is outside the List0 reference picture 1122, only the pixels of the area 1126 included in the List0 reference picture 1122 of the List0 reference block 1124 may be referenced for generating the prediction block of the current block 1102. In addition, pixels in the area 1128 that are not included in the List0 reference picture 1122 of the List0 reference blocks 1124 are not referenced for generating the prediction block of the current block 1102.

Specifically, the first area 1104 of the current block 1102 has corresponding areas 1126 and 1146 in the List0 reference block 1124 and the List1 reference block 1144. Therefore, the first area 1104 may be determined based on the corresponding area 1126 of the List0 reference block 1124 and the corresponding area 1146 of the List1 reference block 1144. At this time, the first area 1104 may be determined by an average or a weighted average of the two corresponding areas 1126 and 1146. The weight applied to the weighted average may be determined based on an adaptive weight value of a coding unit (CU) (bi-prediction with CU-level weight, BCW). Alternatively, the weight applied to the weighted average may be determined based on the temporal distance between the current picture 1100 and the List0 reference picture 1122 and the temporal distance between the current picture 1100 and the List1 reference picture 1142.

In addition, the corresponding area 1148 of the List1 reference block 1144 within the List1 reference picture 1142 only exists for the second area 1106 of the current block 1102. In addition, the corresponding area 1128 of the List0 reference block 1124 does not exist in the List0 reference picture 1122. Therefore, the second area 1106 of the current block 1102 may be determined only based on the corresponding area 1148 of the List1 reference block 1144. In addition, the corresponding area 1128 of the List0 reference block 1124 is not referenced for determining the second area 1106 of the current block 1102.

As in FIG. 11, only for an area where two pictures in both directions may be referenced in a reference block, the two pictures are referenced, and for an area where only one of the two pictures may be referenced, only the referenceable picture is referenced, so that pixels in the repetitive padding area are excluded from motion prediction. Accordingly, as in FIG. 10, since the repetitive padding area is excluded from the prediction process, the prediction accuracy of the current block can be improved.

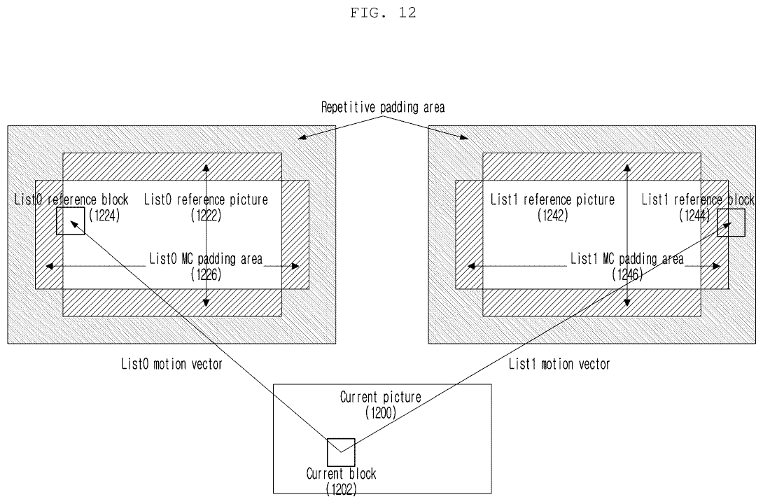

FIG. 12 illustrates an embodiment of a block prediction method by bilateral motion prediction when an extended picture has a motion compensation padding area.

In the cases of FIGS. 9 to 11, since the reference picture is extended according to the repetitive padding method, a bilateral motion prediction method that avoids reference of the repetitive padding region in order to increase prediction accuracy is proposed. However, if the reference picture is extended by the motion compensation padding method, even if part or all of the reference block is outside the reference picture, it may be referenced for the prediction of the current block.

According to FIG. 12, motion compensation padding areas 1226 and 1246 are generated according to a motion compensation method, and a current block 1202 may be predicted based on the motion compensation padding areas 1226 and 1246. According to an embodiment, the motion compensation padding areas 1226 and 1246 may be considered as areas within each reference picture 1222 or 1242.

Therefore, although a part of the List0 reference block 1224 of FIG. 12 is outside the List0 reference picture 1222, since the List0 motion compensation padding region 1226 is considered as an area within the List0 reference picture 1222, the entire List0 reference block 1224 may be used for prediction of the current block 1202.

The List1 reference block 1244 is completely outside the List1 reference picture 1242. However, since the List1 motion compensation padding region 1246 is considered as an area within the List1 reference picture 1242, a part of the List1 reference block 1244 may be used for prediction of the current block 1202 depending on embodiments.

In FIG. 12, the motion compensation padding area is considered as an area within the reference picture. Therefore, the embodiments of FIGS. 9 to 11 may be applied based on the motion compensation padding area being considered as a reference picture. Accordingly, when the motion compensation padding method is applied, the efficiency of bilateral prediction may be increased as the area referenced by prediction is extended.

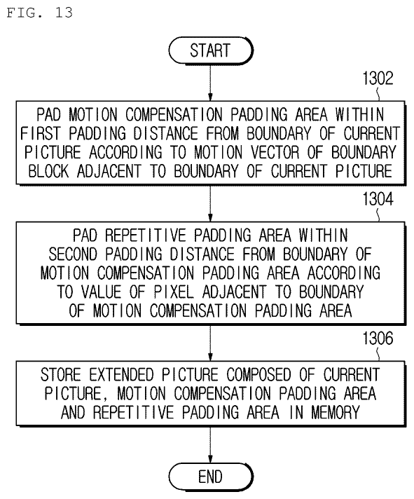

FIG. 13 shows an embodiment of a method of generating and storing an extended picture according to the present invention.

In step 1302, a motion compensation padding area within a first padding distance from the boundary of a current picture is padded according to a motion vector of a boundary block adjacent to the boundary of the current picture.

Step 1302 may include a step of extracting a motion vector from a boundary block, a step of determining a reference block from a motion compensation padding reference picture referenced for motion compensation padding based on the motion vector, a step of determining an adjacent motion compensation padding reference block in a padding direction from the reference block, and a step of padding the motion compensation padding area based on the motion compensation padding reference block. The motion compensation padding reference picture means a reference picture referenced for reconstruction of the boundary block.

According to an embodiment, in the step of determining the motion compensation padding reference block, the motion compensation padding reference block may be determined to include adjacent pixels within the first padding distance in the padding direction from the boundary of the reference block.

According to an embodiment, in the step of determining the motion compensation padding reference block, when the motion compensation padding referenceable distance between the boundary of the reference block and the boundary of the motion compensation padding reference picture is smaller than the first padding distance, the motion compensation padding reference block may be determined to include adjacent pixels within the motion compensation padding referenceable distance in the padding direction from the boundary of the reference block.

According to an embodiment, in the step of padding the motion compensation padding area based on the motion compensation padding reference block, when the motion compensation padding referenceable distance between the boundary of the reference block and the boundary of the motion compensation padding reference picture is smaller than the first padding distance, a motion compensation paddable area of the motion compensation padding area may be padded by the motion compensation padding reference block. The motion compensation paddable area may be determined to be an area within the motion compensation padding referenceable distance from the boundary of the current picture within the motion compensation padding area. In addition, an area that is not a motion compensation paddable area of the motion compensation padding area may be padded based on a pixel value of the motion compensation paddable area.

According to an embodiment, if a motion vector cannot be extracted from the boundary block, the motion compensation padding area is padded according to pixel values adjacent to the boundary of the current picture. For example, if the boundary block is intra-predicted, a motion vector is not extracted from the boundary block.

According to an embodiment, the step of extracting the motion vector from the boundary block may include a step of determining a temporal neighboring block corresponding to a position of the boundary block from a temporal corresponding reference picture of the current picture when the motion vector cannot be extracted from the boundary block, and a step of extracting a motion vector from the temporal neighboring block.

According to an embodiment, the first padding distance may be determined based on at least one of the maximum size of the coding unit, the size of the current picture, or the size of the boundary block. Alternatively, the first padding distance may be determined to be one of 2, 4, 8, 16, 32, 64, 128, or 256.

In step 1304, a repetitive padding area within a second padding distance from the boundary of the motion compensation padding area is padded according to a value of a pixel adjacent to the boundary of the motion compensation padding area.

According to an embodiment, the second padding distance may be determined based on at least one of the maximum size of the coding unit, the size of the current picture, or the size of the boundary block.

In step 1306, an extended picture composed of the current picture, the motion compensation padding area, and the repetitive padding area is generated. In addition, the extended picture is stored in a memory.

According to an embodiment, the size of the extended picture may be determined based on the size of the current picture, regardless of the value of the first padding distance.

The method of generating and storing the extended picture may be applied to an image decoding method and an image encoding method.

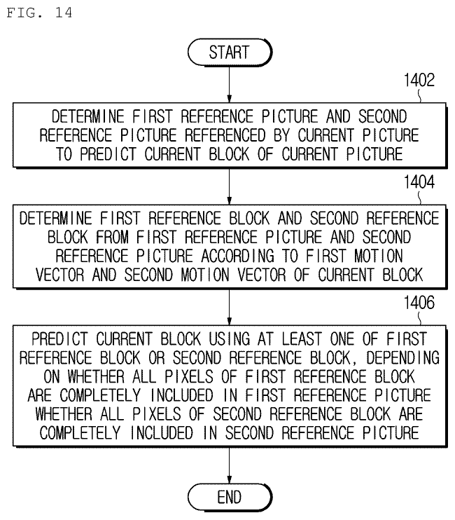

FIG. 14 shows an embodiment of a bilateral inter prediction method according to the present invention.

In step 1402, in order to predict a current block of a current picture, a first reference picture and a second reference picture referenced by the current picture are determined.

In step 1404, a first reference block and a second reference block are determined from the first reference picture and the second reference picture, respectively, according to a first motion vector and a second motion vector of the current block.

In step 1406, the current block is predicted using at least one of the first reference block or the second reference block, depending on whether all pixels of the first reference block are completely included in the first reference picture and whether all pixels of the second reference block are completely included in the second reference picture.

According to an embodiment, if some or all of the pixels of the first reference block are not included in the first reference picture and all the pixels of the second reference block are included in the second reference picture, the current block may be predicted based on the second reference block.

According to an embodiment, if some of the pixels of the first reference block are not included in the first reference picture and all the pixels of the second reference block are included in the second reference picture, a first area of the current block corresponding to positions of pixels included in the first reference picture in the first reference block may be determined by a weighted average of pixels of the first reference block and the second reference block. In addition, a second area of the current block corresponding to positions of pixels not included in the first reference picture in the first reference block may be predicted based only on the second reference block.

According to an embodiment, in determining whether all pixels of the first reference block are included in the first reference picture and whether all pixels of the second reference block are included in the second reference picture, the first motion compensation padding area of the first reference picture may be considered as the first reference picture, and the second motion compensation padding area of the second reference picture may be considered as the second reference picture.

The bilateral inter prediction method may be applied to an image decoding method and an image encoding method.

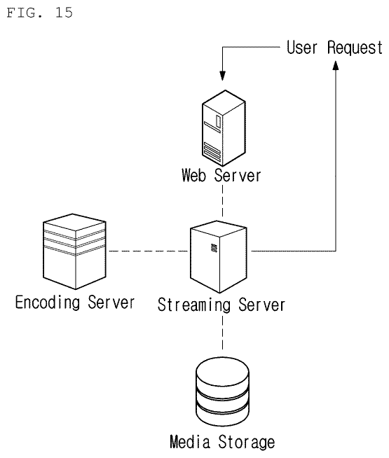

FIG. 15 exemplarily illustrates a content streaming system to which an embodiment according to the present invention is applicable.

As illustrated in FIG. 15, a content streaming system to which an embodiment of the present invention is applied may largely include an encoding server, a streaming server, a web server, a media storage, a user device, and a multimedia input device.

The encoding server compresses content received from multimedia input devices such as smartphones, cameras, CCTVs, etc. into digital data to generate a bitstream and transmits it to the streaming server. As another example, if multimedia input devices such as smartphones, cameras, CCTVs, etc. directly generate a bitstream, the encoding server may be omitted.

The bitstream may be generated by an image encoding method and/or an image encoding apparatus to which an embodiment of the present invention is applied, and the streaming server may temporarily store the bitstream in the process of transmitting or receiving the bitstream.

The streaming server transmits multimedia data to a user device based on a user request via a web server, and the web server may act as an intermediary that informs the user of any available services. When a user requests a desired service from the web server, the web server transmits it to the streaming server, and the streaming server may transmit multimedia data to the user. At this time, the content streaming system may include a separate control server, and in this case, the control server may control commands/responses between devices within the content streaming system.

The streaming server may receive content from a media storage and/or an encoding server. For example, when receiving content from the encoding server, the content may be received in real time. In this case, in order to provide a smooth streaming service, the streaming server may store the bitstream for a certain period of time.

Examples of the user devices may include mobile phones, smartphones, laptop computers, digital broadcasting terminals, personal digital assistants (PDAs), portable multimedia players (PMPs), navigation devices, slate PCs, tablet PCs, ultrabooks, wearable devices (e.g., smartwatches, smart glasses, HMDs), digital TVs, desktop computers, digital signage, etc.

Each server in the above content streaming system may be operated as a distributed server, in which case data received from each server may be distributed and processed.

The above embodiments may be performed in the same or corresponding manner in the encoding apparatus and the decoding apparatus. In addition, an image may be encoded/decoded using at least one or a combination of at least one of the above embodiments.

The order in which the above embodiments are applied may be different in the encoding apparatus and the decoding apparatus. Alternatively, the order in which the above embodiments are applied may be the same in the encoding apparatus and the decoding apparatus.

The above embodiments may be performed for each of the luma and chroma signals. Alternatively, the above embodiments for the luma and chroma signals may be performed identically.

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present invention.

The embodiments may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present invention, or well-known to a person of ordinary skilled in computer software technology field.

A bitstream generated by the encoding method according to the above embodiment may be stored in a non-transitory computer-readable recording medium. In addition, a bitstream stored in the non-transitory computer-readable recording medium may be decoded by the decoding method according to the above embodiment.

Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high level language code that may be implemented by a computer using an interpreter. The hardware devices may be configured to be operated by one or more software modules or vice versa to conduct the processes according to the present invention.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### INDUSTRIAL APPLICABILITY

The present invention may be used in an apparatus for encoding/decoding an image and a recording medium for storing a bitstream.

1. An image decoding method comprising:
padding a motion compensation padding area within a first padding distance from a boundary of a current picture according to a motion vector of a boundary block adjacent to the boundary of the current picture;
padding a repetitive padding area within a second padding area from a boundary of the motion compensation padding area according to a value of a pixel adjacent to the boundary of the motion compensation padding area; and
storing an extended picture composed of the current picture, the motion compensation padding area and the repetitive padding area in a memory.

2. The image decoding method of claim 1, wherein the padding the motion compensation padding area comprises:
extracting a motion vector from the boundary block;
determining a reference block from a motion compensation padding reference picture referenced for motion compensation padding based on the motion vector;
determining an adjacent motion compensation padding reference block in a padding direction from the reference block; and
padding the motion compensation padding area based on the motion compensation padding reference block.

3. The image decoding method of claim 2, wherein in the determining the motion compensation padding reference block, the motion compensation padding reference block is determined to include adjacent pixels within the first padding distance in the padding direction from a boundary of the reference block.

4. The image decoding method of claim 3, wherein in the determining the motion compensation padding reference block, when a motion compensation padding referenceable distance between the boundary of the reference block and the boundary of the motion compensation padding reference picture is smaller than the first padding distance, the motion compensation padding reference block is determined to include adjacent pixels within the motion compensation padding referenceable distance in the padding direction from the boundary of the reference block.

5. The image decoding method of claim 4, wherein in the padding the motion compensation padding area based on the motion compensation padding reference block, when the motion compensation padding referenceable distance between the boundary of the reference block and the boundary of the motion compensation padding reference picture is smaller than the first padding distance, a motion compensation paddable area within the motion compensation padding referenceable distance from the boundary of the current picture of the motion compensation padding area is padded by the motion compensation padding reference block, and
an area that is not the motion compensation paddable area of the motion compensation padding area is padded based on a pixel value of the motion compensation paddable area.

6. The image decoding method of claim 2, wherein when the motion vector cannot be extracted from the boundary block, the motion compensation padding area is padded according to a value of a pixel adjacent to the boundary of the current picture.

7. The image decoding method of claim 2, wherein the extracting the motion vector from the boundary block comprises:
determining a temporal neighboring block corresponding to a position of the boundary block from a temporal corresponding reference picture of the current picture when the motion vector cannot be extracted from the boundary block; and
extracting the motion vector from the temporal neighboring block.

8. The image decoding method of claim 1, wherein the first padding distance is determined based on at least one of a maximum size of a coding unit, a size of the current picture or a size of the boundary block.

9. The image decoding method of claim 1, wherein the first padding distance is determined to be one of 2, 4, 8, 16, 32, 64, 128 or 256.

10. The image decoding method of claim 1, wherein the second padding distance is determined based on at least one of a maximum size of a coding unit, a size of the current picture or a size of the boundary block.

11. The image decoding method of claim 1, wherein a size of the extended picture is determined based on the size of the current picture regardless of a value of the first padding distance.

12. An image encoding method comprising:
padding a motion compensation padding area within a first padding distance from a boundary of a current picture according to a motion vector of a boundary block adjacent to the boundary of the current picture;
padding a repetitive padding area within a second padding area from a boundary of the motion compensation padding area according to a value of a pixel adjacent to the boundary of the motion compensation padding area; and
storing an extended picture composed of the current picture, the motion compensation padding area and the repetitive padding area in a memory.

13. A computer-readable recording medium storing a bitstream generated by an image encoding method, the image encoding method comprising:
padding a motion compensation padding area within a first padding distance from a boundary of a current picture according to a motion vector of a boundary block adjacent to the boundary of the current picture;
padding a repetitive padding area within a second padding area from a boundary of the motion compensation padding area according to a value of a pixel adjacent to the boundary of the motion compensation padding area; and
storing an extended picture composed of the current picture, the motion compensation padding area and the repetitive padding area in a memory.

14. A method of transmitting a bitstream generated by an image encoding method, the method comprising:
encoding an image based on the image encoding method; and
transmitting a bitstream including the encoded image,
wherein the image encoding method comprises:
padding a motion compensation padding area within a first padding distance from a boundary of a current picture according to a motion vector of a boundary block adjacent to the boundary of the current picture;
padding a repetitive padding area within a second padding area from a boundary of the motion compensation padding area according to a value of a pixel adjacent to the boundary of the motion compensation padding area; and
storing an extended picture composed of the current picture, the motion compensation padding area and the repetitive padding area in a memory.

15. An image decoding method comprising:
determining a first reference picture and a second reference picture referenced by a current picture to predict a current block of the current picture;
respectively determining a first reference block and a second reference block from the first reference picture and the second reference picture according to a first motion vector and a second motion vector of the current block; and
predicting the current block using at least one of the first reference block or the second reference block depending on whether all pixels of the first reference block are included in the first reference picture and whether all pixels of the second reference block are included in the second reference picture.

16. The image decoding method of claim 15, wherein in the predicting the current block, when some or all of pixels of the first reference block are not included in the first reference picture and all pixels of the second reference block are included in the second reference picture, the current block is predicted based on the second reference block.

17. The image decoding method of claim 15, wherein when some of pixels of the first reference block are not included in the first reference picture and all pixels of the second reference block are included in the second reference picture, a first area of the current block corresponding to positions of pixels included in the first reference picture in the first reference block is determined by a weighted average of pixels of the first reference block and the second reference block and a second area of the current block corresponding to positions of pixels not included in the first reference picture in the first reference block is predicted based only on the second reference block.

18. The image decoding method of claim 15, wherein in determining whether all pixels of the first reference block are in the first reference picture and whether all pixels of the second reference block are included in the second reference picture, a first motion compensation padding area of the first reference picture is considered as the first reference picture and a second motion compensation padding area of the second reference picture is considered as the second reference picture.

19. An image encoding method comprising:
determining a first reference picture and a second reference picture referenced by a current picture to predict a current block of the current picture;
respectively determining a first reference block and a second reference block from the first reference picture and the second reference picture according to a first motion vector and a second motion vector of the current block; and
predicting the current block using at least one of the first reference block or the second reference block depending on whether all pixels of the first reference block are included in the first reference picture and whether all pixels of the second reference block are included in the second reference picture.

20. (canceled)

21. A method of transmitting a bitstream generated by an image encoding method, the method comprising:
encoding an image based on the image encoding method; and
transmitting a bitstream including the encoded image,
wherein the image encoding method comprises:
determining a first reference picture and a second reference picture referenced by a current picture to predict a current block of the current picture;
respectively determining a first reference block and a second reference block from the first reference picture and the second reference picture according to a first motion vector and a second motion vector of the current block; and
predicting the current block using at least one of the first reference block or the second reference block depending on whether all pixels of the first reference block are included in the first reference picture and whether all pixels of the second reference block are included in the second reference picture.
